(19) United States
(12) Patent Application Publication
(10) Pub. No.: US 2012/0182589 A1
(43) Pub. Date: Jul. 19, 2012

(54) IMAGE PROCESSING APPARATUS AND METHOD OF MANAGING DATA TRANSMISSION

(76) Inventor: Takumi KOMORI, Kanagawa (JP)

(21) Appl. No.: 13/345,926

(22) Filed: Jan. 9, 2012

(30) Foreign Application Priority Data
Jan. 14, 2011 (JP) 2011-006186
Jun. 30, 2011 (JP) 2011-146658

(51) Int. Cl. H04N 1/04

(52) U.S. Cl. 358/406

(57) ABSTRACT

An image processing apparatus includes: an image reading unit that reads an image; an input unit that inputs data acquired by reading an image that is read by the image reading unit into a first storage unit; a read-out unit that reads out and transmits the data stored in the first storage unit; an image forming unit that forms an image on a recording medium by using the transmitted data; a measurement unit that measures time relating to the transmission of the data; and a storage control unit that stores a maximum value of the time measured by the measurement unit into a second storage unit.

### CROSS-REFERENCE TO RELATED APPLICATIONS

The present application claims priority to and incorporates by reference the entire contents of Japanese Patent Application No. 2011-006186 filed in Japan on Jan. 14, 2011 and Japanese Patent Application No. 2011-146658 filed in Japan on Jun. 30, 2011.

### BACKGROUND OF THE INVENTION

1. Field of the Invention

The present invention relates to an image processing apparatus and a method of managing data transmission.

2. Description of the Related Art

There are conventional image processing apparatuses that temporarily store image data output from a scanner in a storage unit via an image processing section and a controller unit and that then transmit the image data stored in the storage unit to a plotter in data units, where each individual data unit corresponds to one line of image data. Such image processing apparatuses consecutively transmit data corresponding to one line in accordance with a line synchronization signal, which is output from a scanner or a plotter at predetermined intervals, as a trigger.

The image processing section and the controller unit transmit data for one line that is set within a period between the line synchronization signals. In a case where it is difficult to transmit data corresponding to one line within a line period, data goes missing; and as a result, an abnormality occurs in the image formed by the plotter.

In order to avoid generation of an abnormal image, there is a known technique in which an adjustment circuit of a controller ASIC harmonizes the line period of the image data (also referred to as scanner data) output from the scanner and another line period of data (also referred to as plotter data) input to the plotter so as to adjust memory access relating to scanner data and printer data.

In addition, as an analysis function at the time of the occurrence of an abnormal image, there is a known technique for detecting the shortfall of a line period of one line data transmission to an image processing ASIC (a line period shortfall detecting mechanism). By using this technique, it can be determined whether the cause of a shortfall of the line period of the data transmission corresponding to one line is due to an “error in the main-scanning setting performed by the image processing section” or due to “no transmission of line data within the line period from the controller unit to the image processing section”.

However, since the order of precedence is fixed in a conventional adjustment circuit, when the product specifications (the operational specifications or the line period specifications of the device) are changed, it is necessary to reconfigure the adjustment circuit (revision of the controller ASIC), and there is a problem with the flexibility of the adjustment function.

In addition, in the abnormal image analysis of a conventional line period shortfall detecting mechanism, in a case where an error occurs due to the shortfall of the line period of the data transmission corresponding to one line, i.e., in a case where “no transmission of line data within the line period from the controller unit to the image processing section” occurs, it is difficult to determine the degree of the shortfall of the line period, which causes degradation of the analysis efficiency.

Here, in Japanese Patent Application Laid-open No. 2004-343624, for the purpose of preventing the generation of an abnormal image in the plotter at the time of the operation of an apparatus, a technique is disclosed in which a congested state is adjusted by temporarily storing image data read by a scanner before transmission of the image data to a controller unit, arbitrarily setting the scanner line period at the time of transmitting the image data to the controller unit, and transmitting the image data to the controller unit at the set scanner line period.

However, according to the conventional technique described above, it is difficult to resolve the problem of low analysis efficiency in a case where an abnormal image is generated by the plotter.

Therefore, there is a need for an image processing technique that resolves the problem of low analysis efficiency in cases where an abnormal image is generated by the plotter.

### SUMMARY OF THE INVENTION

It is an object of the present invention to at least partially solve the problems in the conventional technology.

According to an embodiment, there is provided an image processing apparatus that includes: an image reading unit that reads an image; an input unit that inputs data acquired by reading an image that is read by the image reading unit into a first storage unit; a read-out unit that reads out and transmits the data stored in the first storage unit; an image forming unit that forms an image on a recording medium by using the transmitted data; a measurement unit that measures time relating to the transmission of the data; and a storage control unit that stores a maximum value of the time measured by the measurement unit into a second storage unit.

According to another embodiment, there is provided a method of managing data transmission that is performed in an image processing apparatus that includes: an image reading unit that reads an image; an input unit that inputs data acquired by reading an image that is read by the image reading unit into a first storage unit; a read-out unit that reads out and transmits the data stored in the first storage unit; and an image forming unit that forms an image on a recording medium by using the transmitted data. The method includes: measuring a time relating to the transmission of the data by using a measurement unit; and storing a maximum value of the time measured by the measurement unit into a second storage unit by using a storage control unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating the configuration of an image processing apparatus according to a first embodiment;

FIG. 2 is a diagram illustrating the configuration of a controller ASIC;

FIG. 3 is a diagram illustrating the relation between an FIFO memory, a video-out, and a line period counter;

FIG. 4 is a timing diagram of the operation of the line period counter;

FIG. 5 is a flowchart illustrating the flow of a transmission managing process;

FIG. 6 is a timing diagram illustrating a specific example of the transmission managing process;

FIG. 7 is a diagram illustrating the configuration of a controller ASIC according to a second embodiment;

FIG. 8 is a diagram illustrating an example of communication between the controller ASIC and a memory;

FIG. 9 is a diagram illustrating the occurrence of a line period error;

FIG. 10 is a flowchart illustrating the flow of a priority level adjusting process;

FIG. 11 is a timing diagram of the priority level adjusting process;

FIG. 12 is a diagram illustrating the configuration of a controller ASIC according to a third embodiment;

FIGS. 13A and 13B are diagrams illustrating a FIFO memory; and

FIG. 14 is a flowchart illustrating the flow of the priority level adjusting process.

### DETAILED DESCRIPTION OF THE PREFERRED EMBODIMENTS

Hereinafter, an image processing apparatus and a method of managing data transmission according to embodiments will be described in detail with reference to the accompanying drawings. Although an image processing apparatus according to the embodiment can be applied to a variety of apparatuses, such as a laser printer employing electrophotography, a digital copying machine, a facsimile device, and a digital multi-function peripheral (MFP), in the embodiments described below, an application example applied to a digital copying machine will be illustrated.

### First Embodiment

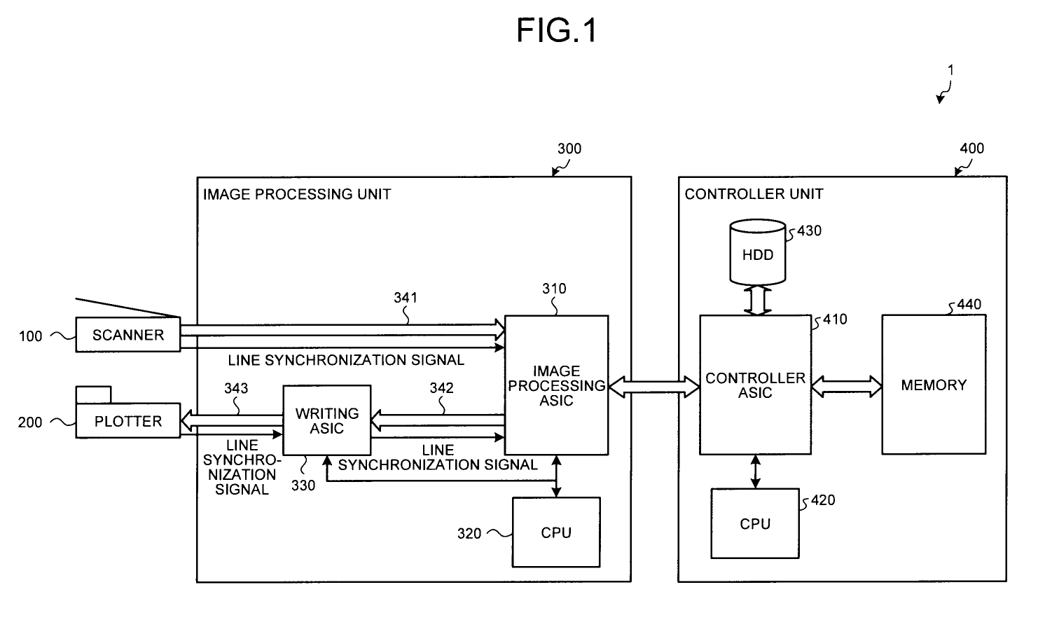

First, a first embodiment will be described. FIG. 1 is a diagram illustrating the configuration of an image processing apparatus according to this embodiment. As illustrated in FIG. 1, an image processing apparatus 1 includes a scanner 100, a plotter 200, an image processing section 300, and a controller unit 400.

The scanner 100 is an image reading unit that optically reads the image of an original. The scanner 100 transmits the read original data to the image processing section 300. When the original data is transmitted, the scanner 100 transmits line data to the image processing section 300 in synchronization with a line synchronization signal.

The plotter 200 is an image forming unit that forms an image on a sheet as a recording medium by using print data that is data transmitted through the image processing section 300 and the controller unit 400. The plotter 200 forms an image on a sheet, for example, by employing electrophotography. The plotter 200 receives the print data from the image processing section 300 and prints the received print data on a sheet. When the image data is received from the image processing section 300, the line data is transmitted to the plotter 200 in accordance with a line synchronization signal. The print data includes the image data.

The image processing section 300 includes an image processing application specific integrated circuit (ASIC) 310, a central processing unit (CPU) 320, and a writing ASIC 330.

The image processing ASIC 310 performs scanner image processing such as a shading correction process for the original data received from the scanner 100 and transmits the processed original data to the controller unit 400. In addition, the image processing ASIC 310 receives the print data from the controller unit 400, performs plotter image processing such as an error diffusion process for the print data, and transmits the processed print data to the writing ASIC 330.

The writing ASIC 330 transmits the print data received from the image processing ASIC 310 to the plotter 200. In addition, the writing ASIC 330 controls the driving of the plotter 200.

The CPU 320 performs register setting and interrupt control of the writing ASIC 330 and the image processing ASIC 310.

A data transmission path 341 between the scanner 100 and the image processing ASIC 310, a data transmission path 342 between the image processing ASIC 310 and the writing ASIC 330, and a data transmission path 343 between the writing ASIC 330 and the plotter 200 are formed from optical cables that are compliant with PCI Express (PCIe).

The controller unit 400 includes a controller ASIC 410, a CPU 420, a hard disk drive (HDD) 430, and a memory 440 as a first storage unit.

The controller ASIC 410 transmits the original data received from the image processing ASIC 310 to the memory 440. In addition, after the original data received from the image processing ASIC 310 is compressed as an image, the controller ASIC 410 stores the compressed original data in the HDD 430, or after the compressed original data is read from the HDD 430 and is expanded as an image, the controller ASIC 410 transmits the expanded original data to the image processing ASIC 310.

The HDD 430 stores the original data or the like. The memory 440 temporarily stores the original data or intermediate compressed data. The CPU 420 performs registry setting or interrupt control of the controller ASIC 410.

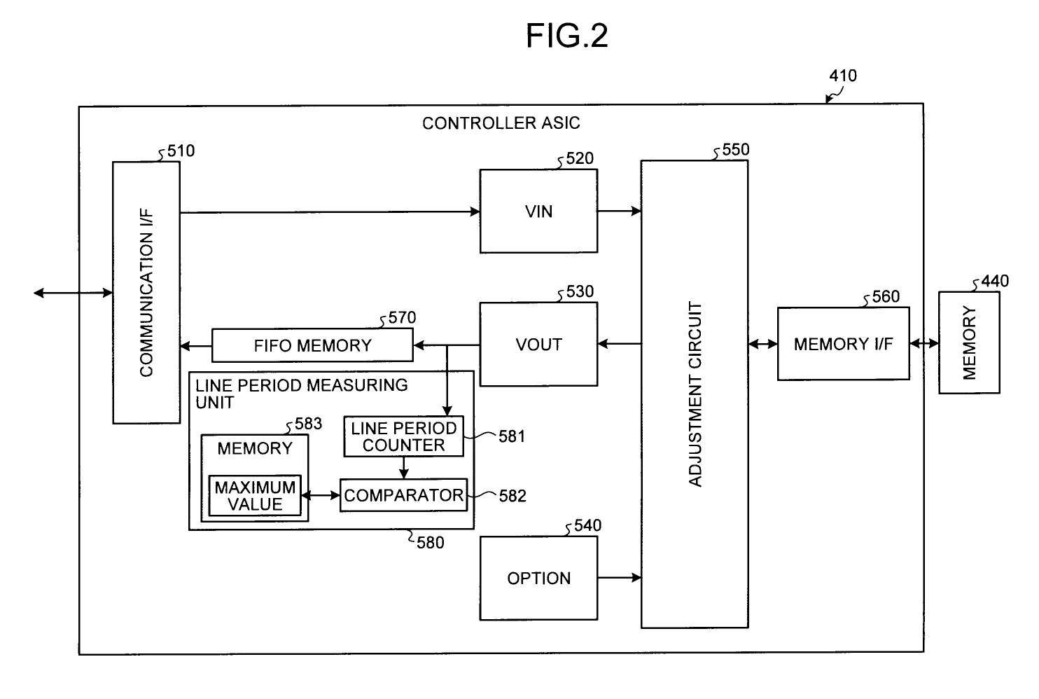

Next, the configuration of the controller ASIC 410 will be described with reference to FIG. 2. FIG. 2 is a diagram illustrating the configuration of the controller ASIC 410.

As illustrated in FIG. 2, the controller ASIC 410 includes: a communication interface (COMMUNICATION I/F in the figure) 510; a video-in (VIN in the figure) 520; a video-out (VOUT in the figure) 530; an option (OPTION in the figure) 540; an adjustment circuit 550; a memory interface (MEMORY I/F in the figure) 560; a first-in-first-out (FIFO) memory 570 as a third storage unit; and a line period measuring unit 580.

The communication interface 510 is connected to the image processing ASIC 310. The communication interface 510 is an interface that is compliant with PCI Express. The communication interface 510 has functions of transmitting the original data received from the image processing ASIC 310 to the video-in 520 and transmitting the print data stored in the FIFO memory 570 to the image processing ASIC 310.

The video-in 520 is an interface that has the function of accessing the memory 440 through the adjustment circuit 550 so as to store the original data at a set address in the memory 440. This video-in 520 serves as an input unit and inputs the print data that is acquired by reading an image through the scanner to the memory 440.

The video-out 530 is an interface that has a function of reading the print data stored in the memory 440 from a set address through the adjustment circuit 550 and transmitting the read print data to the FIFO memory 570. In other words, this video-out 530 serves as a reading unit, reads the print data stored in the memory 440, and transmits the read print data. The video-out 530 reads the print data stored in the memory 440 in units of one line data and inputs the read print data to the FIFO memory 570. Here, the one line data is data corresponding to one line in the main-scanning direction in a printing operation of the plotter 200.

The option 540, for example, is an HDD, a compression/expansion unit, or the like and accesses the memory 440 through the adjustment circuit 550 so as to read data from or to write data into the memory 440.

The adjustment circuit 550 is an adjustment unit that adjusts accesses to the memory 440. Described in detail, the adjustment circuit 550 adjusts memory accesses that are access requests for the memory 440 from the video-in 520, the video-out 530, and the option 540.

The memory interface 560 is connected to the adjustment circuit 550 and the memory 440. This memory interface 560, for example, is an interface that is compliant with PCI Express.

The FIFO memory 570 is a memory that temporarily stores one line data as the print data.

The line period measuring unit 580 includes a line period counter 581, a comparator 582, and a memory 583.

The line period counter 581 is a measurement unit that measures the time relating to the transmission of the print data. The line period counter 581 measures the time during which data corresponding to one line of the print data is input to the FIFO memory 570. In other words, the line period counter 581 measures the transmission time of one line data that is transmitted by the video-out 530 from the memory 440 to the FIFO memory 570 as the time relating to the transmission of the print data. Alternatively, the line period counter 581 may be configured to measure the time in which data of the print data corresponding to one line is read from the FIFO memory 570.

The comparator 582 is a storage control unit that stores a maximum value of the time (transmission time) measured by the line period counter 581 in the memory 583 as a second memory.

The comparator 582 compares the time (that is, the maximum value of the transmission time) that has already been stored in the memory 583 with the latest time (transmission time) measured by the line period counter 581 and, in a case where the value of the latest time (transmission time) is more than the time (the maximum value of the transmission time) that has already been stored in the memory 583, updates the time stored in the memory 583 with the latest time (transmission time). Here, for convenience of the description, the time measured by the line period counter 581 may be also referred to as a line period counter value.

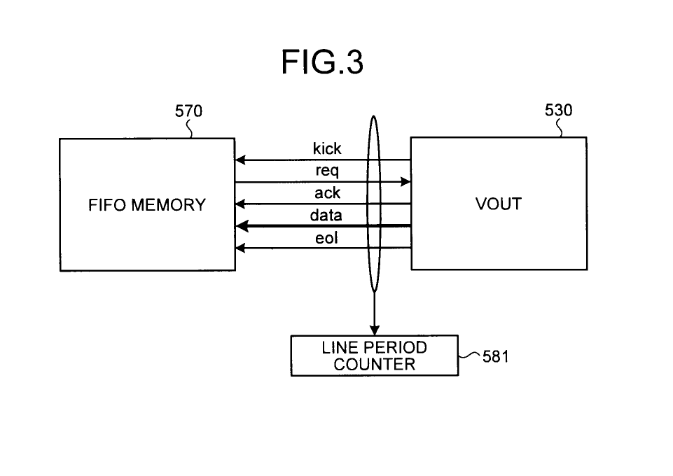

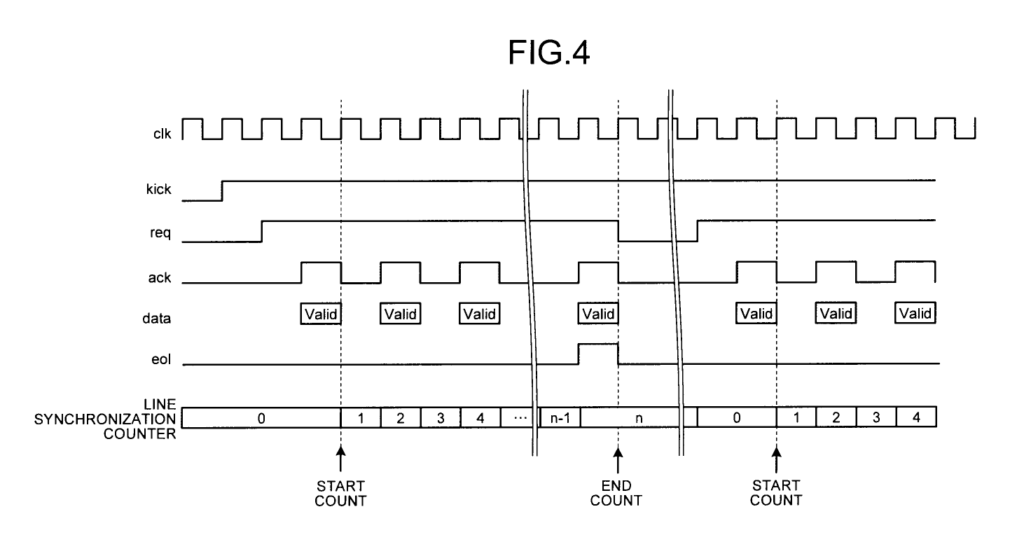

FIG. 3 is a diagram illustrating the relation between the FIFO memory 570, the video-out 530, and the line period counter 581; and FIG. 4 is a timing diagram of the operation of the line period counter 581.

As illustrated in FIG. 3, the FIFO memory 570 transmits a req signal to the video-out 530. The req signal is a transmission request signal that requests the transmission of the print data. Meanwhile the video-out 530 transmits a kick signal, an ack signal, the print data (DATA in the figure), and an eol signal to the FIFO memory 570. The ack signal is a transmission permission signal that represents the permission of transmission. The eol signal is a signal that represents the final portion of data of the print data that corresponds to one line. As can be understood from FIG. 4, the kick signal is active during the transmission period of the print data. In a case where the transmission request through the req signal and the transmission permission through the ack signal are enacted, data of the print data that corresponds to one line is stored in the FIFO memory 570. The operational timing of the measurement start of the line period counter 581 is at the time of the generation of a transaction of the first req signal/ack signals of data of the print data that corresponds to one line. On the other hand, the operational timing of the measurement end of the line period counter 581 is at the time of detecting the eol signal. The line period counter 581 measures the transmission time of data by counting clock (clk) signals from the time of measurement start to the time of measurement end.

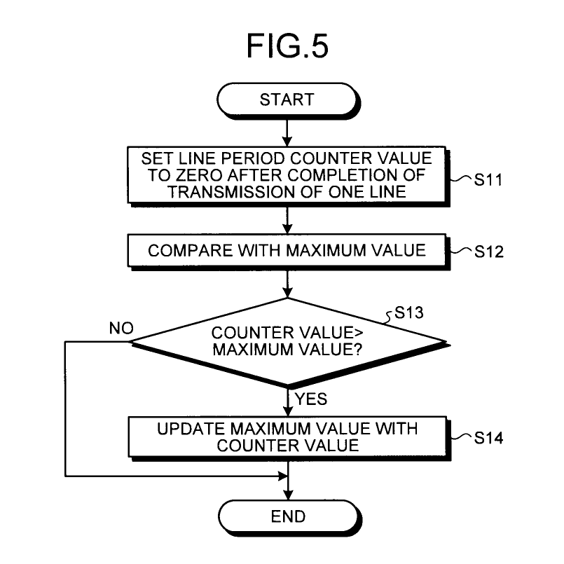

Next, a transmission managing process that is performed by the line period measuring unit 580 will be described with reference to FIG. 5. FIG. 5 is a flowchart illustrating the flow of the transmission managing process.

First, after the eol signal is detected, in other words, after the transmission of data of the print data corresponding to one line, which is performed by the video-out 530, has been completed, the line period measuring unit 580 inputs a line period counter value (the measured value of the line period counter) to the comparator 582 in Step S11.

Next, the comparator 582 compares the input line period counter value with the maximum value of the line period counter value until now that is stored in the memory 583 in Step S12. In a case where the line period counter value is more than the line period counter value until now that is stored in the memory 583 (YES in Step S13), the comparator 582 updates the maximum value of the line period counter value that is stored in the memory 583 with the input line period counter value of this time in Step S14. On the other hand, in a case where the line period counter value of this time is less than or equal to the maximum value of the line period counter value until now that is stored in the memory 583 (NO in Step S13), the comparator 582 does not update the maximum value of the line period counter value that is stored in the memory 583 but maintains the maximum value.

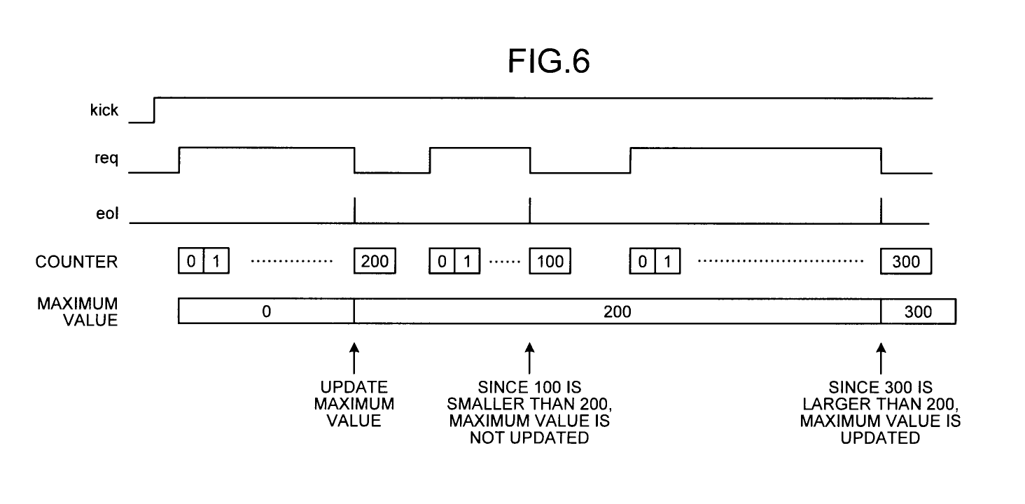

Next, a specific example of the transmission managing process will be described with reference to FIG. 6. FIG. 6 is a timing diagram illustrating a specific example of the transmission managing process. This example is an example of a transmission process of data of the print data that corresponds to the first three lines. In this example, when the transmission of data corresponding to the first line has been completed, the line period counter value of this time (in this example, 200) is stored in the memory 583. The reason for this is that, when the transmission of data of the first line is performed, “0” is stored in the memory 583 as its initial value. When the transmission of data of the second line has been completed, the line period counter value=100<maximum value=200, and accordingly, the maximum value of the line period counter value that is stored in the memory 583 is not updated. On the other hand, when the transmission data of the third line has been completed, the line period counter value=300>maximum value=200, and accordingly, the maximum value 300 of the line period counter value that is stored in the memory 583 is updated with 300.

As described above, in this embodiment, the line period measuring unit 580 stores the maximum value of the measured value (the line period counter value) of the line period counter 581 in the memory 583. Accordingly, in a case where an abnormal image is generated in the plotter 200, the maximum value of the measured value of the line period counter 581 that is stored in the memory 583 is compared with the line period time of the image processing apparatus 1. Therefore, in a case where the maximum value is less than the line period time of the image processing apparatus 1, it can be determined that the cause of the abnormal image is in the image processing section 300. On the other hand, in a case where the maximum value is more than the line period time of the image processing apparatus 1, it can be determined that the cause of the abnormal image is present in the controller unit 400. As above, according to this embodiment, the cause of the abnormal image can be easily specified. Therefore, the analysis efficiency of a cause of a case where an abnormal image is generated in the plotter 200 can be improved.

In addition, as described above, the line period counter 581 performs counting on the read-out side of the FIFO memory 570, whereby the read-out time of the image processing section 300 can be measured. By acquiring the read-out time of the image processing section 300, it can be determined whether or not the image processing section 300 reads out the line data within the line period time.

### Second Embodiment

Next, a second embodiment will be described. The same reference numerals are assigned to the same elements as that of the first embodiment, and duplicate descriptions thereof will not be presented here.

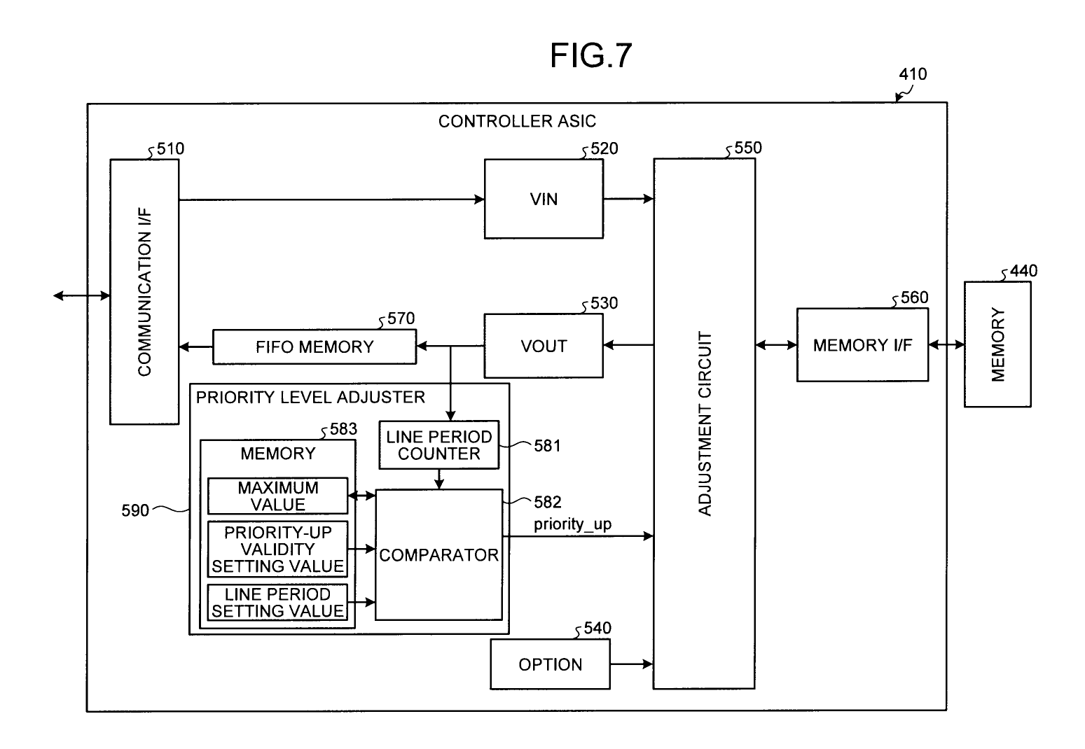

FIG. 7 is a diagram illustrating the configuration of a controller ASIC 410 according to this embodiment. In this embodiment, instead of the line period measuring unit 580 described in the first embodiment, a priority level adjuster 590 is disposed, which is different from the first embodiment.

The basic configuration of the priority level adjuster 590 is the same as that of the line period measuring unit 580 of the first embodiment, and the priority level adjuster 590 includes a line period counter 581, a comparator 582, and a memory 583. The line period counter 581, the comparator 582, and the memory 583 have the functions and configurations described below in addition to the functions and configurations described in the first embodiment.

The comparator 582 serves as a priority level changing unit and performs a priority level adjusting process, in which the adjustment circuit 550 sets the priority level of the video-out 530 to access the memory 440 at the highest level, in a case where the time measured by the line period counter 581 exceeds a specified time.

Here, in this embodiment, similarly to the first embodiment, the video-out 530 inputs data of the print data corresponding to one line that is stored in the memory 440 to the FIFO memory 570. Then, the line period counter 581 measures the transmission time of data corresponding to one line as the time relating to the transmission of the print data. Here, it is assumed that the above-described transmission time measured by the line period counter 581 is T, a line period setting value as the specified transmission time is A, and a priority-up validity setting value as the specified value is B. In such a case, in a case where T=A×B/100, the comparator 582 determines whether or not the input of data corresponding to one line to the FIFO memory 570 has been completed by the video-out 530. Then, when the input of the data corresponding to one line to the FIFO memory 570 has not been completed by the video-out 530, the comparator 582 requests the adjustment circuit 550 to set the priority level of the access of the video-out 530 to the memory 440 to the highest level.

The line period setting value and the priority-up validity setting value are stored in the memory 583. The line period setting value is used for setting the line period. The priority-up validity setting value is used for setting the operational timing for raising the priority level of the access of the video-out 530 to the memory 440. The comparator 582 controls a Priority_up signal based on the measured time of the line period counter 581, the priority-up validity setting value, and the line period setting value. In a case where the Priority_up signal is “1”, it represents a request for setting the priority level of the access of the video-out 530 to the memory 440 at the highest level. On the other hand, in a case where the Priority_up signal is “0”, it represents a withdrawal of the request for setting the priority level of the access of the video-out 530 to the memory 440 at the highest level.

The adjustment circuit 550 sets the priority level of the access of the video-out 530 to the memory 440 as the highest level while the above-described request is received from the comparator 582.

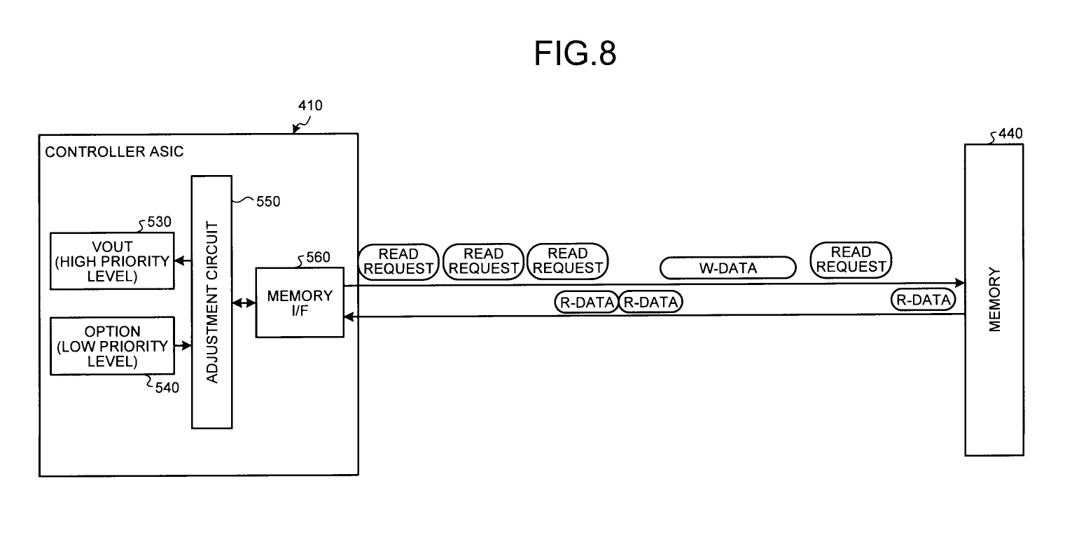

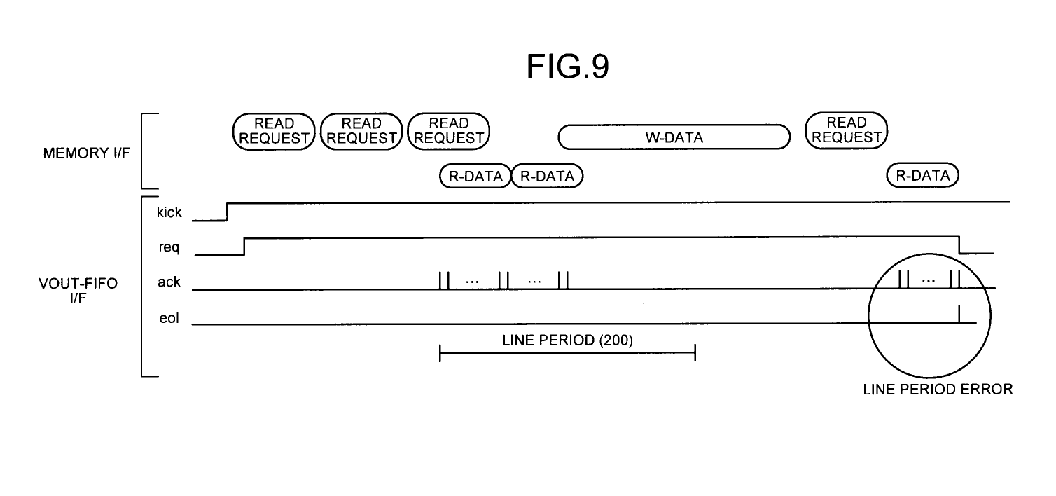

Here, a line period error will be described with reference to FIGS. 8 and 9. FIG. 8 is a diagram illustrating an example of communication between the controller ASIC 410 and the memory 440, and FIG. 9 is a diagram illustrating the occurrence of a line period error.

First, it is assumed that data communication is performed between the controller ASIC 410 and the memory 440 as illustrated in FIG. 8 as an example. In this example, a read request or a write request (W-DATA) is transmitted from the controller ASIC 410 to the memory 440, and data (R-DATA) corresponding to the read request is transmitted from the memory 440 to the controller ASIC 410.

In this embodiment, since the memory interface 560 is an interface that is compliant with PCI Express, the read request corresponds to a split transaction. This read request is made by the video-out 530. In this embodiment, although the adjustment circuit 550 sets the priority level of the access of the video-out 530 to the highest level, in a case where a burst write (for example, a write request of the option 540) having a big size of data is inserted between read requests, the throughput of the reception side decreases. As a result, it affects the data transmission to the video-out 530 that requires isochronism of lines. FIG. 9 illustrates the appearance of the occurrence of a line period error due to the occurrence of a burst write of the option 540 for the specified line period.

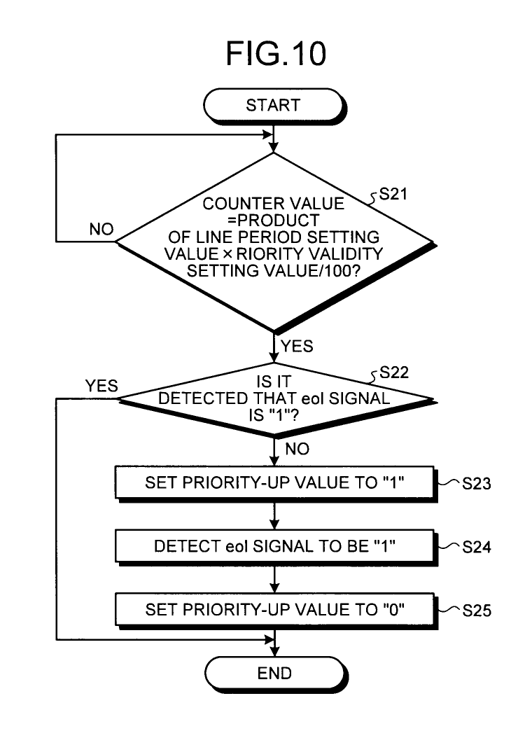

In this embodiment, the occurrence of the line period error is suppressed by the priority level adjusting process of the priority level adjuster 590 described above. Hereinafter, the flow of the priority level adjusting process will be described in detail with reference to a flowchart illustrated in FIG. 10.

First, the priority level adjuster 590 monitors a line period counter value up to operational timing at which the priority level is adjusted (NO in Step S21). Whether the operational timing at which the priority level is adjusted is determined based on the results of determining whether or not T=A×B/100.

When it is the timing at which the priority level is adjusted (YES in Step S21), the priority level adjuster 590 determines whether or not the eol signal is “1”, in other words, whether or not the transmission of data corresponding to one line has been completed in Step S22. In a case where the eol signal is not “1”, in other words, in a case where the transmission of data corresponding to one line has not been completed (NO in Step S22), the comparator 582 transmits a priority_up signal that includes information in which the priority up value is set to “1” to the adjustment circuit 550 in Step S23. Accordingly, the comparator 582 instructs the adjustment circuit 550 to receive a transmission request only from the video-out 530 by asserting the priority_up signal for the adjustment circuit 550. Thereafter, in a case where the eol signal is detected to be “1” in Step S24, the comparator 582 negates the priority_up signal by transmitting a priority_up signal including information in which the priority up value is set to “0” to the adjustment circuit 550 in Step S25. In addition, in a case where the eol signal is “1” in Step S22, in other words, in a case where the transmission of data corresponding to one line has been completed (YES in Step S22), the comparator 582 does not transmit a priority_up signal to the adjustment circuit 550.

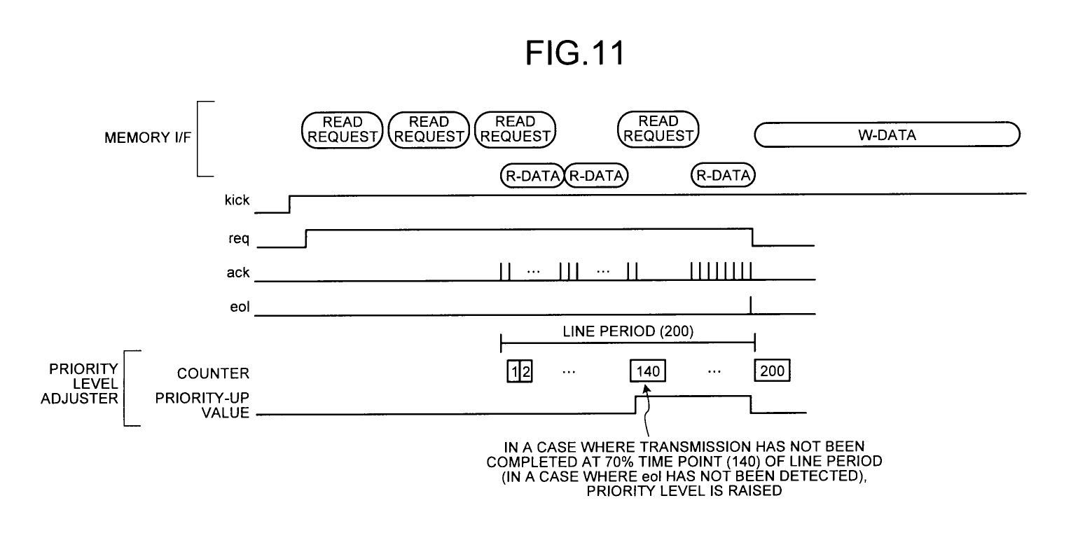

Next, a specific example of the priority level adjusting process will be described with reference to FIG. 11. FIG. 11 is a timing diagram of the priority level adjusting process.

This is an example of the priority level adjusting process when the line period setting value is 200, and the priority-up validity setting value is 70. As illustrated in FIG. 11, it can be understood that, when the counter value of the line period counter 581 is 140 (T=200×70/140), the eol is not detected to be “1”, in other words, the transmission of data corresponding to one line has not been completed, and accordingly, a Priority_up signal is asserted, and the priority level of the access to the memory 440, when stated differently, the priority level of the data transmission is set at the highest level for the video-out 530.

As described above, in this embodiment, since the priority level of the access of the video-out 530 to the memory 440 can be changed by using the priority-up validity setting value, the priority level of the access to the memory 440 can be changed without changing the circuit configuration of the adjustment circuit 550. In other words, in this embodiment, by applying a feedback of a priority-up request to the adjustment circuit 550 based on the line period setting value and the priority-up validity setting value, the priority level of the access to the memory 440 can be dynamically controlled. Accordingly, the generation of an abnormal image due to the controller unit 400 can be prevented in advance.

In addition, while the a priority-up request for the video-out 530 is received from the comparator 582, the adjustment circuit 550 sets the priority level of the access of the video-out 530 to the memory 440 at the highest level. Accordingly, in a case where there is a possibility of generating an abnormal image can be prevented in advance.

### Third Embodiment

Next, a third embodiment will be described. The same reference numerals are assigned to the same elements as that of the second embodiment, and duplicate descriptions thereof will not be presented here.

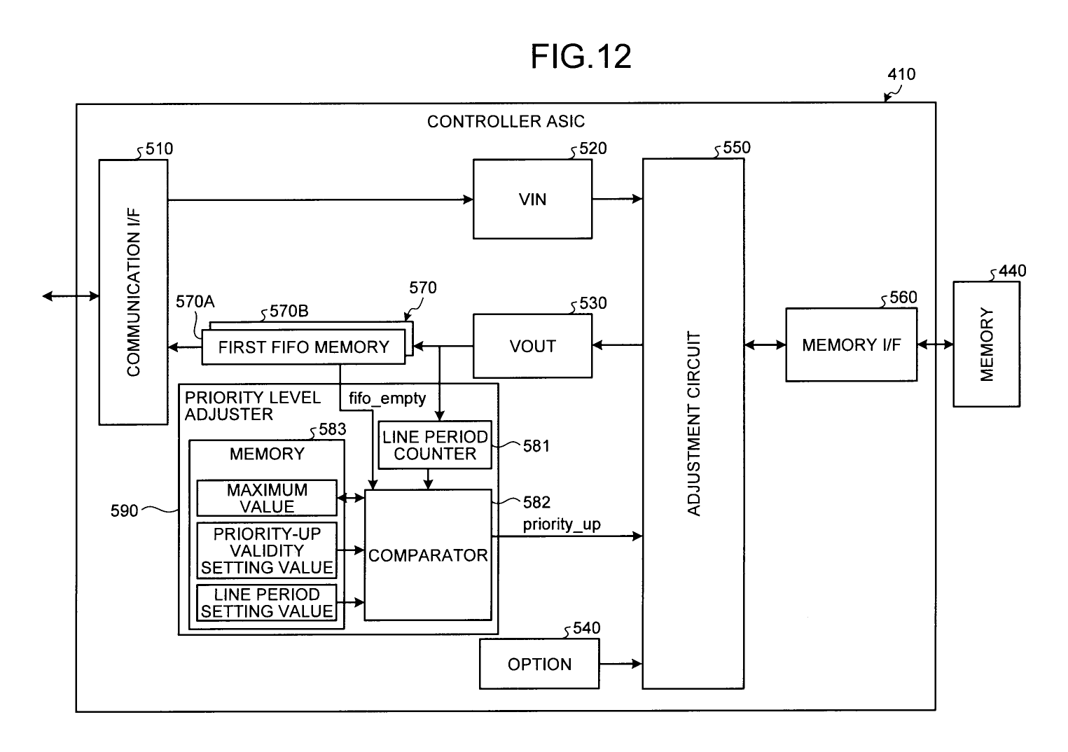

FIG. 12 is a diagram illustrating the configuration of a controller ASIC 410 according to this embodiment. In this embodiment, the FIFO memory 570 includes a first FIFO memory 570A and a second FIFO memory 570B, which is different from the second embodiment. The FIFO memory 570 of this embodiment corresponds to a fourth storage unit.

The first FIFO memory 570A and the second FIFO memory 570B correspond to a plurality of portions of the FIFO memory 570 each capable of storing data corresponding to one line. Accordingly, the FIFO memory 570 of this embodiment can store data corresponding to two lines. The FIFO memory 570 is a toggle FIFO memory. The number of plurality of portions of the FIFO memory 570 each capable of storing data corresponding to one line is not limited to two but may be three or more.

The basic configuration of the priority level adjuster 590 is the same as that of the second embodiment, and the priority level adjuster 590 includes a line period counter 581, a comparator 582, and a memory 583.

The video-out 530 inputs data of the print data corresponding to one line that is stored in the memory 440 to the FIFO memory 570. Then, the line period counter 581 measures the transmission time of the data corresponding to one line as the time relating to the transmission of the print data. In a case where T=A×B/100, and a data accumulation amount of at least one of a plurality of portions (the first FIFO memory 570A and the second FIFO memory 570B) of the FIFO memory 570 is a specified amount less than the amount of the data corresponding to one line, the comparator 582 determines whether or not the input of the data corresponding to one line to the FIFO memory 570, which is performed by the video-out 530, has been completed. In this embodiment, as an example of the case where the data accumulation amount is a specified amount less than the amount of data corresponding to one line, a state in which the data accumulation state is an empty state, in other words, the amount of accumulated data is “0” is employed. In addition, T, A, and B illustrated in the above-described equation, similarly to those of the second embodiment, are the above-described transmission time measured by the line period counter 581, the line period setting value as a specified transmission time, and the priority-up validity setting value as a specified setting value. When the input of the data corresponding to one line to the FIFO memory 570, which is performed by the video-out 530, has not been completed, the comparator 582 requests the adjustment circuit 550 to set the priority level of the access of the video-out 530 to the memory 440 at the highest level.

Here, an example of the case where the data accumulation state of at least one portion of the plurality of portions (the first FIFO memory 570A and the second FIFO memory 570B) of the FIFO memory 570 is in the empty state which is a state in which either the first FIFO memory 570A or the second FIFO memory 570B is an empty state. In other words, that is a state in which data stored in one of the first FIFO memory 570A or the second FIFO memory 570B is read by the communication interface 510.

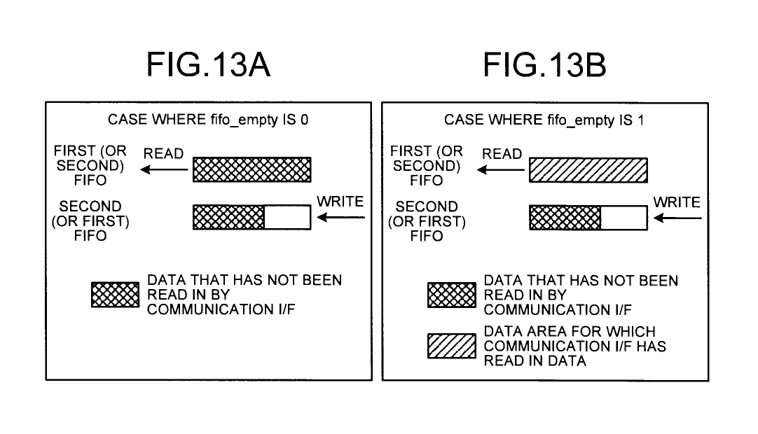

As a signal that indicates whether or not the data accumulation state of either the first FIFO memory 570A or the second FIFO memory 570B is the empty state, a fifo_empty signal is used. As illustrated in FIG. 13A, in a case where there is data in both the first FIFO memory 570A and the second FIFO memory 570B that has not been read by the communication interface 510, in other words, data that has not been transmitted to the communication interface 510, the fifo_empty signal is “0”. FIG. 13A illustrates in detail a state in which data corresponding to one line is in the middle of the process of being written into one of the first FIFO memory 570A and the second FIFO memory 570B, and the entire data corresponding to one line stored in the other of the first FIFO memory 570A and the second FIFO memory 570B has not been transmitted to the communication interface 510.

On the other hand, As illustrated in FIG. 13B, in a case where there is no data in either the first FIFO memory 570A or the second FIFO memory 570B that has not been read by the communication interface 510, in other words, data that has not been transmitted to the communication interface 510, the fifo_empty signal is “1”. FIG. 13B illustrates in detail a state in which data corresponding to one line is in the middle of the process of being written into one of the first FIFO memory 570A and the second FIFO memory 570B, and the entire data corresponding to one line stored in the other of the first FIFO memory 570A and the second FIFO memory 570B has been transmitted to the communication interface 510. The fifo_empty signal is transmitted from the FIFO memory 570 to the comparator 582. Here, although the condition for the fifo_empty signal of “1” is the state in which the entire data stored in the first FIFO memory 570A or the second FIFO memory 570B has been read by the communication interface 510, the condition is not limited thereto, and, for example, the condition for the fifo_empty signal of “1” may be a state in which, of the data corresponding to one line, the amount of data that has not been read by the communication interface 510 is a specified data amount which is more than zero (but near empty).

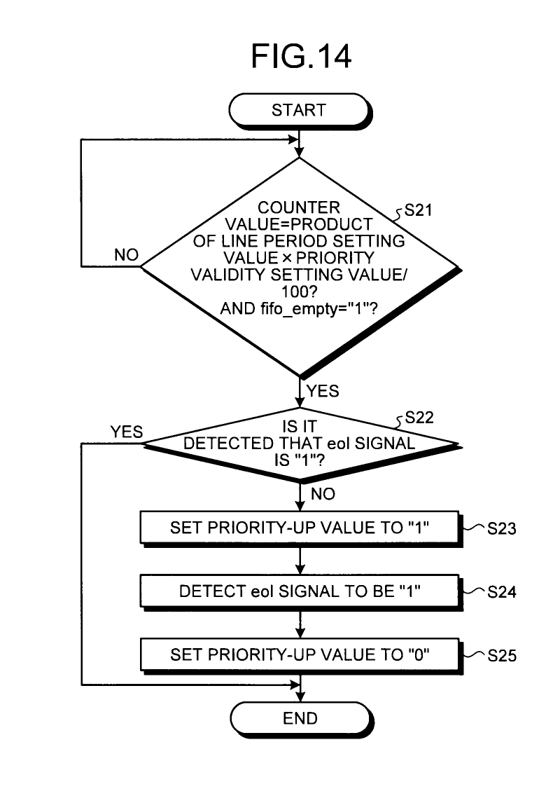

Next, the flow of the priority level adjusting process according to this embodiment will be described with reference to a flowchart illustrated in FIG. 14.

First, the priority level adjuster 590 monitors the line period counter value and the fifo_empty signal until the timing at which the priority level is adjusted (NO in Step S21). Whether or not the timing at which the priority level is adjusted is based on the results of determination on whether or not T=A×B/100 and the resulting fifo_empty signal.

In a case where T=A×B/100 and the fifo_empty signal is “1”, the priority level adjuster 590 determines that it is the timing at which the priority level is adjusted (YES in Step S21). Then, similarly to the second embodiment, the process of Steps S22 to S25 is performed. In other words, in this embodiment, the Priority_up signal is controlled based on the fifo_empty signal.

As described above, according to this embodiment, since the priority level of the access of the video-out 530 to the memory 440 can be changed based on the priority-up validity setting value, the priority level of the access to the memory 440 can be changed without changing the circuit configuration of the adjustment circuit 550. In other words, in this embodiment, the priority level of the access to the memory 440 can be dynamically controlled by applying feedback of a priority-up request to the adjustment circuit 550 based on the line period setting value and the priority-up validity setting. Accordingly, the generation of an abnormal image due to the controller unit 400 can be prevented in advance.

In addition, in this embodiment, the data accumulation states of the first FIFO memory 570A and the second FIFO memory 570B are monitored, and, when one of them is empty, the comparator 582 makes a request such that the adjustment circuit 550 sets the priority level of the access of the video-out 530 to the memory 440 at the highest level. Therefore, in addition to the data transmission to the video-out 530, the acquisition of a bus for the data transmission to the option 540 can be improved.

According to the present embodiment, a storage control unit stores a maximum value of time measured by a measurement unit in a second storage unit, and accordingly, by using the maximum value of time that is stored in the second storage unit, the analysis efficiency for a cause of a case where an abnormal image is generated in an image forming unit can be improved.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image processing apparatus comprising:
an image reading unit that reads an image;
an input unit that inputs data acquired by reading an image that is read by the image reading unit into a first storage unit;
a read-out unit that reads out and transmits the data stored in the first storage unit;
an image forming unit that forms an image on a recording medium by using the transmitted data;
a measurement unit that measures time relating to the transmission of the data; and
a storage control unit that stores a maximum value of the time measured by the measurement unit into a second storage unit.

2. The image processing apparatus according to claim 1, wherein
the storage control unit
compares the time that has already been stored in the second storage unit with a latest time measured by the measurement unit, and
updates the time stored in the second storage unit with the latest time in a case where a value of the latest time is larger than the time that has been stored in the second storage unit.

3. The image processing apparatus according to claim 1, wherein
the reading unit inputs the data stored in the first storage unit into a third storage unit as data corresponding to one line.

4. The image processing apparatus according to claim 3, wherein
the measurement unit measures a time in which data corresponding to one line out of the data is input into the third storage unit.

5. The image processing apparatus according to claim 3, wherein
the measurement unit measures a time in which data corresponding to one line out of the data is read out from the third storage unit.

6. The image processing apparatus according to claim 1, further comprising:
an adjustment unit that adjusts access to the first storage unit; and
a priority level changing unit that, in a case where the time measured by the measurement unit exceeds a specified time, makes the adjustment unit set the priority level of access to the first storage unit by the reading unit to the highest level.

7. The image processing apparatus according to claim 6,
wherein the reading unit inputs data corresponding to one line out of the data stored in the first storage unit into a third storage unit,
wherein the measurement unit measures a transmission time of the data corresponding to one line as a time relating to the transmission of the data, and
wherein, in a case where T=A×B/100, in which the transmission time measured by the measurement unit is T, a specified transmission time is A, and a specified setting value is B,
the priority level changing unit determines whether or not input of the data corresponding to one line into the third storage unit, which is performed by the reading unit, has been completed, and,
when the input of the data corresponding to one line into the third storage unit, which is performed by the reading unit, has not been completed,
the adjustment unit is requested to set the priority level of the access to the first storage unit by the reading unit to the highest level.

8. The image processing apparatus according to claim 6,
wherein the reading unit inputs data corresponding to one line out of the data stored in the first storage unit into a fourth storage unit,
wherein the fourth storage unit includes a plurality of portions, each portion being capable of storing the data corresponding to one line;
wherein the measurement unit measures a transmission time of the data corresponding to one line as the time relating to a transmission of the data, and
wherein,
in a case where T=A×B/100, in which the transmission time measured by the measurement unit is T, a specified transmission time is A, and a specified setting value is B, and a data accumulation amount of at least one portion of the plurality of portions of the fourth storage unit is a specified amount less than an amount of the data corresponding to one line,
the priority level changing unit determines whether or not input of the data corresponding to one line into the fourth storage unit, which is performed by the reading unit, has been completed, and,
when the input of the data corresponding to one line into the fourth storage unit, which is performed by the reading unit, has not been completed,
the adjustment unit is requested to set the priority level of the access to the first storage unit by the reading unit to the highest level.

9. The image processing apparatus according to claim 7, wherein
the adjustment circuit sets the priority level of the access to the first storage unit by the reading unit to the highest level while the request is being received from the priority changing unit.

10. The image processing apparatus according to claim 8, wherein
the adjustment circuit sets the priority level of the access to the first storage unit by the reading unit to the highest level while the request is being received from the priority changing unit.

11. A method of managing data transmission that is performed in an image processing apparatus that includes an image reading unit that reads an image; an input unit that inputs data acquired by reading an image that is read by the image reading unit into a first storage unit; a read-out unit that reads out and transmits the data stored in the first storage unit; and an image forming unit that forms an image on a recording medium by using the transmitted data, the method comprising:
measuring a time relating to the transmission of the data by using a measurement unit; and
storing a maximum value of the time measured by the measurement unit in a second storage unit by using a storage control unit.
